(19) United States
(12) Patent Application Publication
(10) Pub. No.: US 2025/0139720 A1
(43) Pub. Date: May 1, 2025

(54) METHODS, SYSTEMS, APPARATUSES, AND DEVICES FOR PERSONALIZING MENUS OF RESTAURANTS BASED ON PREFERENCES

(71) Applicant: Konstantin Vishnikin, Pine Bush, NY (US)

(72) Inventor: Konstantin Vishnikin, Pine Bush, NY (US)

(21) Appl. No.: 18/835,409

(22) PCT Filed: Jun. 21, 2023
(86) PCT No.: PCT/US2023/025815

§ 371 Date: Aug. 2, 2024

Related U.S. Application Data
(60) Provisional application No. 63/413,621, filed on Oct. 6, 2022.

(51) Int. Cl. G06Q 50/12; G06N 3/044; G06N 3/045; G06N 3/0464

(52) U.S. Cl. CPC G06Q 50/12; G06N 3/044; G06N 3/045; G06N 3/0464

(57) ABSTRACT

Disclosed herein is a method for personalizing menus of restaurants based on preferences, in accordance with some embodiments. Accordingly, the method includes receiving at least one request associated with at least one user from at least one device, obtaining at least one menu associated with at least one restaurant based on the at least one request, receiving at least one preference from at least one device, translating the at least one content associated with the at least one dish based on the at least one preference by implementing at least one machine learning model, generating at least one personalized menu of the at least one restaurant for the at least one user based on the translating, transmitting the at least one personalized menu to the at least one device, and storing the at least one machine learning model.

### CROSS-REFERENCE TO RELATED APPLICATION

This application claims the benefit of U.S. Provisional Patent Application No. 63/413,621, titled “METHODS AND SYSTEMS FOR FACILITATING CONVERTING A FOOD MENU BASED ON USER PREFERENCES”, filed 6 Oct. 2022, which is incorporated by reference herein in its entirety.

### FIELD OF THE INVENTION

Generally, the present disclosure relates to the field of data processing. More specifically, the present disclosure relates to methods, systems, apparatuses, and devices for personalizing menus of restaurants based on preferences.

### BACKGROUND OF THE INVENTION

The field of data processing is technologically important to several industries, business organizations, and/or individuals.

Individuals visiting a country with an unknown language face a lot of problems in communicating and presenting their thoughts. When ordering food, individuals cannot understand and order food at a restaurant whose menu is written in an unknown language. In this situation, the individuals are helpless and can only use the internet to translate the menu. This process is time-consuming. Further, the country may have a different currency. Consequently, the menu may show the price of the food in the currency native to the country. Further, the individual finds it difficult to understand the price point of the restaurant and the food.

Existing techniques for facilitating personalizing menus of restaurants based on preferences are deficient with regard to several aspects. For instance, the current technologies do not convert textual content describing dishes on the menu into graphical content that is renderable on a device used by individuals to view the menu. As a result, different technologies are needed for converting the textual content into graphical content that is suitably rendered on the device used by the individuals. Furthermore, the current technologies do not take into account output devices that are used in conjunction with the device to view the menu in an extended reality. As a result, different technologies are needed for converting the menu in a way in which the menu may be viewed in the extended reality on the output devices. Furthermore, the current technologies require the personal information of individuals for determining preferences of the individual which poses a privacy risk. As a result, different technologies are needed that translate the contents of the menu based on indications of the preferences received from a device.

Therefore, there is a need for improved methods, systems, apparatuses, and devices for personalizing menus of restaurants based on preferences that may overcome one or more of the above-mentioned problems and/or limitations.

### SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method for personalizing menus of restaurants based on preferences, in accordance with some embodiments. Accordingly, the method may include a step of receiving, using a communication device, at least one request associated with at least one user from at least one device. Further, the method may include a step of obtaining, using a processing device, at least one menu associated with at least one restaurant based on the at least one request. Further, the at least one menu may include at least one content associated with at least one dish on the at least one menu. Further, the method may include a step of receiving, using the communication device, at least one preference from at least one device. Further, the at least one preference may include at least one preferred characteristic associated with the at least one content and at least one device characteristic associated with the at least one device. Further, the method may include a step of translating, using the processing device, the at least one content associated with the at least one dish based on the at least one preference by implementing at least one machine learning model. Further, the at least one machine learning model may include at least one convolutional neural network (CNN) model and at least one recurrent neural network (RNN) model. Further, the at least one RNN model may be trained for converting at least one original characteristic of at least one text of the at least one content to the at least one preferred characteristic based on the at least one preferred characteristic. Further, the at least one CNN model may be trained for generating at least one media content for the at least one dish renderable on the at least one device based the at least one content, the at least one text with the at least one preferred characteristic, and the at least one device characteristic. Further, the translating of the at least one content may include the converting of the at least one original characteristic of the at least one text of the at least one content and the generating of the at least one media content. Further, the method may include a step of generating, using the processing device, at least one personalized menu of the at least one restaurant for the at least one user based on the translating. Further, the at least one personalized menu may include the at least one media content for the at least one dish. Further, the method may include a step of transmitting, using the communication device, the at least one personalized menu to the at least one device. Further, the method may include a step of storing, using a storage device, the at least one machine learning model.

Further disclosed herein is a system for personalizing menus of restaurants based on preferences, in accordance with some embodiments. Accordingly, the system may include a communication device, a processing device, and a storage device. Further, the communication device may be configured for receiving at least one request associated with at least one user from at least one device. Further, the communication device may be configured for receiving at least one preference from at least one device. Further, the at least one preference may include at least one preferred characteristic associated with the at least one content and at least one device characteristic associated with the at least one device. Further, the communication device may be configured for transmitting at least one personalized menu to the at least one device. Further, the processing device may be communicatively coupled with the communication device. Further, the processing device may be configured for obtaining at least one menu associated with at least one restaurant based on the at least one request. Further, the at least one menu may include at least one content associated with at least one dish on the at least one menu. Further, the processing device may be configured for translating the at least one content associated with the at least one dish based on the at least one preference by implementing at least one machine learning model. Further, the at least one machine learning model may include at least one convolutional neural network (CNN) model and at least one recurrent neural network (RNN) model. Further, the at least one RNN model may be trained for converting at least one original characteristic of at least one text of the at least one content to the at least one preferred characteristic based on the at least one preferred characteristic. Further, the at least one CNN model may be trained for generating at least one media content for the at least one dish renderable on the at least one device based the at least one content, the at least one text with the at least one preferred characteristic, and the at least one device characteristic. Further, the translating of the at least one content may include the converting of the at least one original characteristic of the at least one text of the at least one content and the generating of the at least one media content. Further, the processing device may be configured for generating the at least one personalized menu of the at least one restaurant for the at least one user based on the translating. Further, the at least one personalized menu may include the at least one media content for the at least one dish. Further, the storage device may be communicatively coupled with the processing device. Further, the storage device may be configured for storing the at least one machine learning model.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

FIG. 1 is an illustration of an online platform consistent with various embodiments of the present disclosure.

FIG. 2 is a flowchart of a method 200 for personalizing menus of restaurants based on preferences, in accordance with some embodiments.

FIG. 3 is a flowchart of a method 300 for personalizing menus of restaurants based on preferences, in accordance with some embodiments.

FIG. 4 is a block diagram of a system 400 for personalizing menus of restaurants based on preferences, in accordance with some embodiments.

FIG. 5 is a block diagram of the system 400, in accordance with some embodiments.

FIG. 6 is a block diagram of the system 400, in accordance with some embodiments.

FIG. 7 is a block diagram of the system 400, in accordance with some embodiments.

FIG. 8 is a block diagram of the system 400, in accordance with some embodiments.

FIG. 9 is a block diagram of the system 400, in accordance with some embodiments.

FIG. 10 is a block diagram of a system 1000 for facilitating converting a food menu based on user preferences, in accordance with some embodiments.

FIG. 11 is a flow chart of a method 1100 for facilitating converting a food menu based on user preferences, in accordance with some embodiments.

FIG. 12 is a screenshot of a user interface 1200 of a software application displaying a food menu in an original language and an original currency, in accordance with some embodiments.

FIG. 13 is a screenshot of a user interface 1300 of the software application displaying the food menu in a preferred language and a preferred currency, in accordance with some embodiments.

FIG. 14 is a block diagram of a computing device for implementing the methods disclosed herein, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of methods, systems, apparatuses, and devices for personalizing menus of restaurants based on preferences, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor, and at least one actuator. Examples of the one or more client devices and/or the server computer may include, a desktop computer, a laptop computer, a tablet computer, a personal digital assistant, a portable electronic device, a wearable computer, a smartphone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice based interface, gesture based interface, etc.) for use by the one or more users and/or a network interface for communicating with other devices over a communication network. Accordingly, the server computer and/or computing device may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer and/or computing device may include a communication device configured for communicating with one or more external devices. The one or more external devices may include, for example, but are not limited to, a client device, a third party database, a public database, a private database, and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer and/or computing device may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data fingerprinting, role-based access control, and so on.

Further, one or more steps of the method disclosed herein may be initiated, maintained, controlled, and/or terminated based on a control input received from one or more devices operated by one or more users such as, for example, but not limited to, an end user, an admin, a service provider, a service consumer, an agent, a broker and a representative thereof. Further, the user as defined herein may refer to a human, an animal, or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human readable secret data (e.g. username, password, passphrase, PIN, secret question, secret answer, etc.) and/or possession of a machine readable secret data (e.g. encryption key, decryption key, bar codes, etc.) and/or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human readable data from an input device such as, for example, a keyboard, a keypad, a touch-screen, a microphone, a camera, and so on. Likewise, the one or more steps may include receiving, using the communication device, the one or more embodied characteristics from one or more biometric sensors.

Further, one or more steps of the method may be automatically initiated, maintained, and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device, etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, an indoor location sensor etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data, and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The present disclosure describes methods, systems, apparatuses, and devices for personalizing menus of restaurants based on preferences.

Further, the present disclosure describes methods and systems for facilitating converting a food menu based on user preferences. Further, the disclosed system may be configured for text translation and currency conversion based on profile preference. Further, in an instance, a user may be traveling to Turkey for vacation (or some other non-English-speaking country) and the user may be dining at some local restaurant. Further, the user may be lucky if the restaurant has a menu with pictures, otherwise, the user conventionally has to do two things. First, search on the internet for each dish—to see what it is. And then, additionally, the user may convert prices to understand the price point of the place.

Further, the disclosed system may be associated with a software platform (such as a software application and website). Now, then the restaurant using the disclosed system to build their menu online—the menu becomes much easier to use for travelers. Further, under the user profile online or in the software application, the user may choose a preferred language and currency (that may not be location-based). Further, wherever the user may travel, the user may see menus and prices in the preferred language of the user.

Further, based on the user's preferences—every menu which opens directly in the software application or from a QR code menu may be translated into a preferred language and the currency may be converted to preferred based on the current price. Further, web servers may be checking the user's IP and if it's matching user profile, the menu may be translated into the preferred language and the currency may be converted to preferred based on the current price.

Further, the disclosed system may be configured to automatically translate text and convert currency using machine learning. Further, the disclosed system may be configured for determining transaction costs for various transactions for users (such as travelers). Further, the transaction costs vary for credit cards, debit cards, prepaid cards, travel cards, etc. Further, based on using artificial intelligence, the disclosed system may be configured to analyze the real-time change in currency conversion rates and automatically/dynamically adapt the menu based on the currency conversion rates.

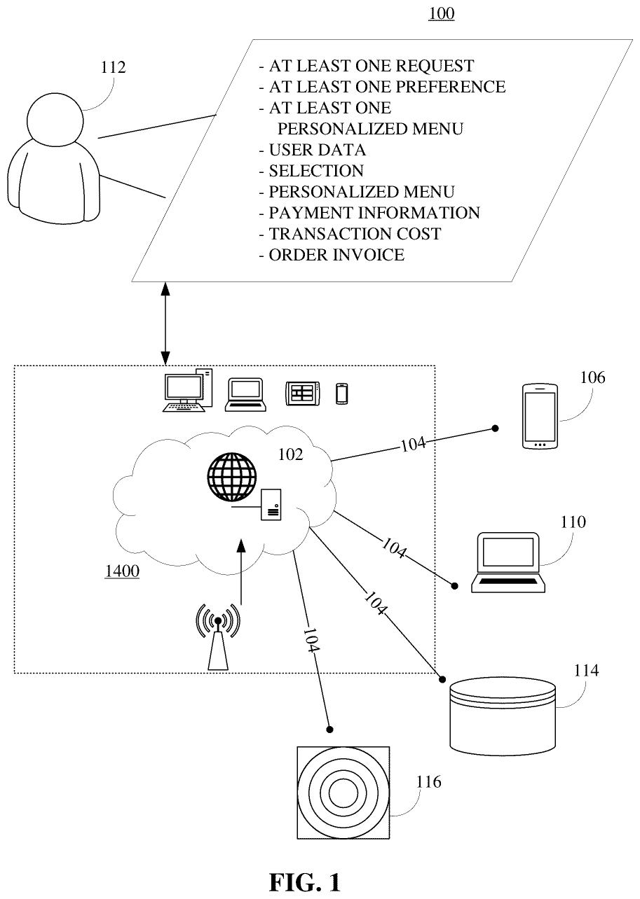

FIG. 1 is an illustration of an online platform 100 consistent with various embodiments of the present disclosure. By way of non-limiting example, the online platform 100 to facilitate personalizing menus of restaurants based on preferences may be hosted on a centralized server 102, such as, for example, a cloud computing service. The centralized server 102 may communicate with other network entities, such as, for example, a mobile device 106 (such as a smartphone, a laptop, a tablet computer, etc.), other electronic devices 110 (such as desktop computers, server computers, etc.), databases 114, and sensors 116 over a communication network 104, such as, but not limited to, the Internet. Further, users of the online platform 100 may include relevant parties such as, but not limited to, end-users, administrators, service providers, service consumers, and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 1400.

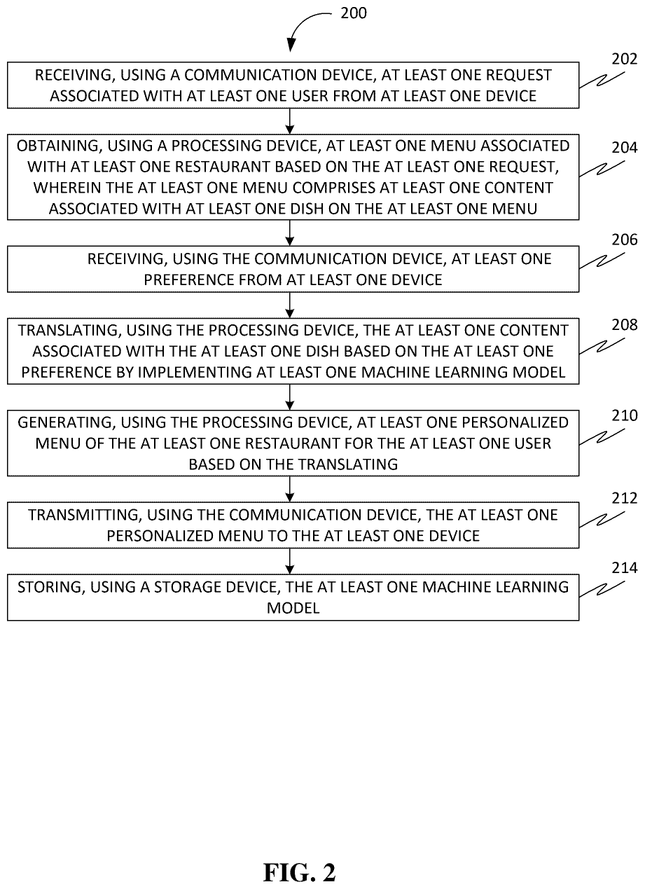

FIG. 2 is a flowchart of a method 200 for personalizing menus of restaurants based on preferences, in accordance with some embodiments. Accordingly, at 202, the method 200 may include receiving, using a communication device (such as the communication device 402), at least one request associated with at least one user from at least one device (such as the at least one device 502). Further, the at least one user may be an individual. Further, the at least one request may include a request for viewing the menus of the restaurants. Further, the at least one request may include identifiers for dishes, restaurants, etc. Further, the at least one device may include a computing device, a client device, a Kiosk, etc. Further, the at least one request may include a food request.

Further, at 204, the method 200 may include obtaining, using a processing device (such as the processing device 404), at least one menu associated with at least one restaurant based on the at least one request. Further, the at least one menu may include at least one food menu of the at least one restaurant. Further, the at least one menu may include at least one content associated with at least one dish on the at least one menu. Further, the at least one content describes the at least one dish. Further, the at least one content may include a text, an image, a video, an audio, etc.

Further, at 206, the method 200 may include receiving, using the communication device, at least one preference from at least one device. Further, the at least one preference may include at least one preferred characteristic associated with the at least one content and at least one device characteristic associated with the at least one device. Further, the at least one preferred characteristic may include a preferred language for viewing a text describing the at least one dish, a preferred currency for viewing a price of the at least one dish, a preferred environment for viewing the at least content, a requirement of viewing an image of the at least one dish, etc. Further, the at least one device characteristic may include memory size, processing capacity, network strength, network bandwidth, screen parameters of a display screen, etc., of the at least one device. Further, the at least one preference may include a user preference.

Further, at 208, the method 200 may include translating, using the processing device, the at least one content associated with the at least one dish based on the at least one preference by implementing at least one machine learning model. Further, the at least one machine learning model may include at least one convolutional neural network (CNN) model and at least one recurrent neural network (RNN) model. Further, the at least one RNN model may be trained for converting at least one original characteristic of at least one text of the at least one content to the at least one preferred characteristic based on the at least one preferred characteristic. Further, the at least one original characteristic may include an original and/or default language of a text describing the at least one dish, an original and/or default currency for marking a price of the at least one dish, an original and/or default environment (such as 2D environment, 3D environment, extended reality environment, etc.) for presenting the at least content, etc., provided by the at least one restaurant. Further, the at least one CNN model may be trained for generating at least one media content for the at least one dish renderable on the at least one device based the at least one content, the at least one text with the at least one preferred characteristic, and the at least one device characteristic. Further, the at least one media content may include text, audio, 2D video, 3D video, 2D image, 3D image, extended reality object, etc. Further, the translating of the at least one content may include the converting of the at least one original characteristic of the at least one text of the at least one content and the generating of the at least one media content. Further, the at least one media content may be generated with at least one media content characteristic that makes the at least one media content renderable on the at least one device comprising the at least one device characteristic. Further, the at least one media content characteristic may include a number of frames per second, interlaced vs progressive, aspect ratio, color model and depth, video quality, video compression method, stereoscopic, etc. Further, the at least one device may be limited by the at least one device characteristic for rendering the at least one media content. Further, the generating of the at least one media content based on the at least one device characteristic makes the at least one media content renderable on the at least one device. Further, the implementing may include executing the at least one machine learning model on the processing device.

Further, at 210, the method 200 may include generating, using the processing device, at least one personalized menu of the at least one restaurant for the at least one user based on the translating. Further, the at least one personalized menu may include the at least one media content for the at least one dish.

Further, at 212, the method 200 may include transmitting, using the communication device, the at least one personalized menu to the at least one device. Further, the at least one device may include at least one output device (such as the display screen) for presenting the at least one modified menu by rendering the at least one media content.

Further, at 214, the method 200 may include storing, using a storage device (such as the storage device 406), the at least one machine learning model.

Further, in some embodiments, the at least one device may include at least one sensor and a first processing device. Further, the at least one sensor may be configured for generating at least one sensor data based on detecting at least one visual characteristic of the at least one user. Further, the at least one visual characteristic may include a color of a face, a shape of the face, a color of an iris, a color of hair, a stature, a build of a body, etc., of the at least one user. Further, the at least one sensor may include at least one camera for capturing images of the at least one user and an artificial intelligence (AI) visual processor for classifying and recognizing visual characteristics of the at least one user. Further, the first processing device may be communicatively coupled with the at least one sensor. Further, the first processing device may be configured for analyzing the at least one sensor data. Further, the first processing device may be configured for determining a race and a physical trait of the at least one user based on the analyzing of the at least one sensor data. Further, the physical trait may include height, body shape, facial features, hair features, iris features, etc. Further, the race may include Middle Eastern, Hispanic (Cuban, Mexican, Puerto Rican, etc.), Irish, Native American (Iroquois, Cherokee, Navajo, Haida, etc.), Jewish, Pacific Islander (Samoan, Tongan, Maori, Tahitian, etc.), Caucasian (British, French, German, etc.), Black (Kenyan, Nigerian, Somalian, biracial, etc.), Asian (Japanese, Korean, Chinese, Cambodian, etc.), etc. Further, the first processing device may be configured for determining a geographical region for the at least one user based on the race and the physical trait of the at least one user by implementing at least one first machine learning model. Further, the geographical region may include a country, a region, etc. Further, the geographical region corresponds to the race. Further, the at least one first machine learning model may be trained on a dataset comprising at least one classification of the geographical region based on a combination of the race and the physical trait in at least one proportion. Further, the first processing device may be configured for generating at least one of a preferred language and a preferred currency based on the geographical region. Further, the at least one preferred characteristic may include at least one of the preferred language and the preferred currency. Further, the receiving of the at least one preference may be further based on the generating of at least one of the preferred language and the preferred currency.

Further, in some embodiments, the at least one device may be communicatively couplable to at least one output device. Further, the at least one output device may include a display screen, a 3D display screen, a projector, an extended reality headset, etc. Further, the at least one device may include at least one first sensor and a first processing device. Further, the at least one first sensor may be configured for generating at least one indication based on detecting a communicative coupling of the at least one output device with the at least one device. Further, the communicative coupling may include connecting the at least one output device with the at least one device. Further, the first processing device may be communicatively coupled with the at least one first sensor. Further, the first processing device may be configured for obtaining at least one output device data associated with the at least one output device based on the at least one indication. Further, the first processing device may be configured for analyzing the at least one output device data. Further, the first processing device may be configured for generating at least one output device characteristic of the at least one output device based on the analyzing of the at least one output device data. Further, the at least one output device characteristic may include an output format for presenting the at least one media content. Further, the output format may include text, graphics, tactile, audio, video, hologram, 3D video, 3D image, extended reality, etc. Further, the at least one device characteristic may include the at least one output device characteristic. Further, the receiving of the at least one preference may be based on the generating of the at least one output device characteristic.

Further, in some embodiments, the at least one device may include at least one second sensor, a storage device, and a first processing device. Further, the at least one second sensor may be configured for generating at least one location data based on detecting a current location of the at least one user. Further, the at least one second sensor may include a location sensor. Further, the storage device may be configured for storing at least one payment information associated with the at least one user. Further, the at least one payment information may include at least one account comprising at least one amount in at least one currency. Further, the at least one account corresponds to at least one wallet, at least one bank account, etc. Further, the at least one currency may include a cryptocurrency, dollar, euro, etc. Further, the first processing device may be communicatively coupled with the at least one second sensor and the storage device. Further, the first processing device may be configured for determining a local currency used for payment in the current location based on the at least one location data. Further, the first processing device may be configured for analyzing the local currency and the at least one payment data. Further, the first processing device may be configured for determining a preferred currency from the at least one currency associated with the at least one account of the at least one user. Further, the at least one preferred characteristic may include the preferred currency. Further, the receiving of the at least one preference may be based on the determining of the preferred currency.

Further, in some embodiments, the at least one device may include at least one card reader and a first processing device. Further, the at least one card reader may be configured for reading at least one payment information comprised in at least one card by detecting the at least one card. Further, the at least one card reader may include near field communication (NFC) card reader. Further, the at least one card may be a physical card comprising at least one NFC chip. Further, the at least one NFC chip stores the at least one payment information. Further, the first processing device may be communicatively coupled with the at least one card reader. Further, the first processing device may be configured for analyzing the at least one payment information. Further, the first processing device may be configured for determining a geographical region associated with the at least one user based on the analyzing of the at least one payment information. Further, the first processing device may be configured for generating at least one of a preferred language and a preferred currency based on the geographical region. Further, the at least one preferred characteristic may include at least one of the preferred language and the preferred currency. Further, the receiving of the at least one preference may be further based on the generating of at least one of the preferred language and the preferred currency.

Further, in some embodiments, the at least one content may include at least one textual content. Further, the translating of the at least one content may include translating the at least one textual content into at least one graphical content. Further, the at least one graphical content may include 2D images, 3D images, 2D videos, 3D videos, holograms, extended reality objects, etc. Further, the generating of the at least one media content for the at least one dish renderable on the at least one device may include generating the at least one graphical content for the at least one dish renderable on the at least one device based the at least one textual content. Further, the at least one media content may include the at least one graphical content.

Further, in some embodiments, the at least one device may include at least one microphone and a first processing device. Further, the at least one microphone may be configured for generating at least one utterance data by detecting an utterance from the at least one user. Further, the utterance may include a word, a sentence, etc., associated with a dialect, a language, etc. Further, the first processing device may be communicatively coupled with the at least one microphone. Further, the first processing device may be configured for analyzing the at least one utterance data. Further, the first processing device may be configured for determining a dialect associated with the at least one user based on the analyzing of the at least one utterance data. Further, the first processing device may be configured for determining a geographical region for the at least one user based on the dialect of the at least one user by implementing at least one third machine learning model. Further, the at least one third machine learning model may be trained on a dataset comprising at least one classification of the geographical region based on the dialect. Further, the first processing device may be configured for generating at least one of a preferred language and a preferred currency based on the geographical region. Further, the at least one preferred characteristic may include at least one of the preferred language and the preferred currency. Further, the receiving of the at least one preference may be further based on the generating of at least one of the preferred language and the preferred currency.

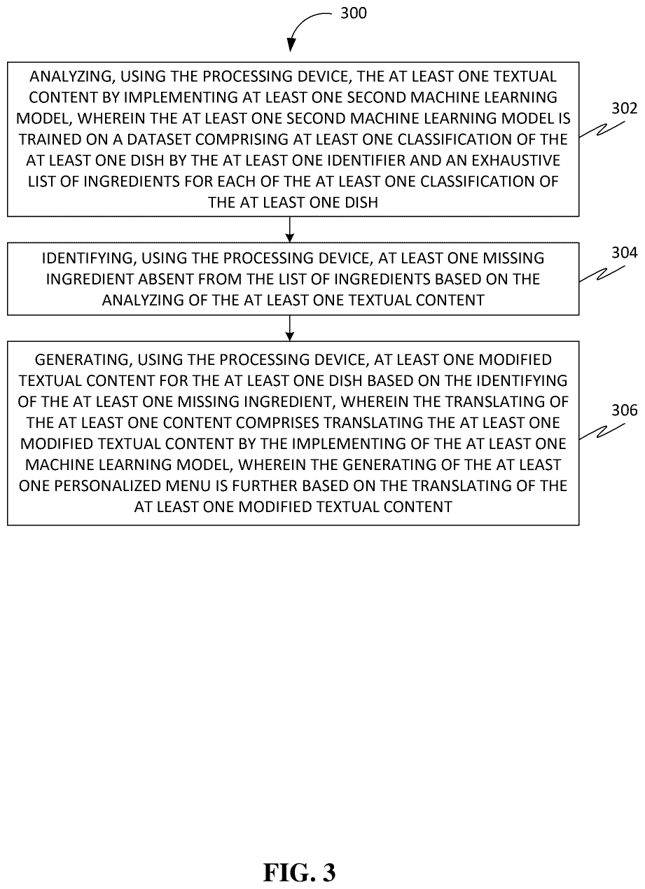

FIG. 3 is a flowchart of a method 300 for personalizing menus of restaurants based on preferences, in accordance with some embodiments. Further, the at least one content may include at least one textual content comprising a list of ingredients for the at least one dish and at least one identifier of the at least one dish.

Further, at 302, the method 300 may include analyzing, using the processing device, the at least one textual content by implementing at least one second machine learning model. Further, the at least one second machine learning model may be trained on a dataset comprising at least one classification of the at least one dish by the at least one identifier and an exhaustive list of ingredients for each of the at least one classification of the at least one dish.

Further, at 304, the method 300 may include identifying, using the processing device, at least one missing ingredient absent from the list of ingredients based on the analyzing of the at least one textual content. and

Further, at 306, the method 300 may include generating, using the processing device, at least one modified textual content for the at least one dish based on the identifying of the at least one missing ingredient. Further, the translating of the at least one content may include translating the at least one modified textual content by the implementing of the at least one machine learning model. Further, the generating of the at least one personalized menu may be further based on the translating of the at least one modified textual content.

Further, in some embodiments, the converting of the at least one original characteristic of the at least one text of the at least one content may include converting the at least one original characteristic of at least one modified text of the at least one modified textual content to the at least one preferred characteristic based on the at least one preferred characteristic. Further, the translating of the at least one modified textual content may include the converting of the at least one original characteristic of the at least one modified text of the at least one modified textual content.

Further, in an embodiment, the generating of the at least one media content for the at least one dish renderable on the at least one device may include generating the at least one media content for the at least one dish renderable on the at least one device based on the at least one modified textual content, the at least one modified text with the at least one preferred characteristic, and the at least one device characteristic. Further, the translating of the at least one modified textual content further may include the generating of the at least one media content for the at least one dish renderable on the at least one device based on the at least one modified textual content, the at least one modified text with the at least one preferred characteristic.

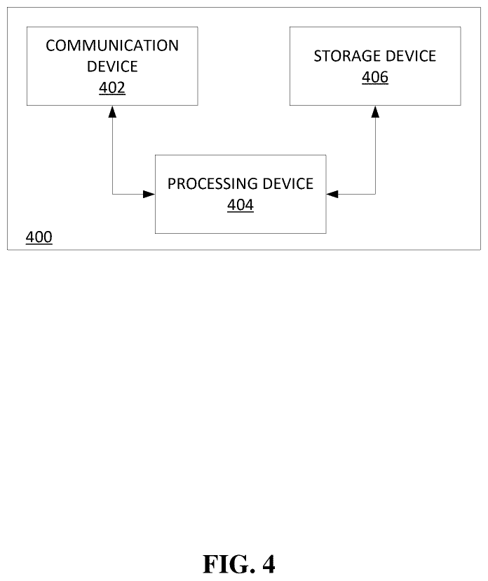

FIG. 4 is a block diagram of a system 400 for personalizing menus of restaurants based on preferences, in accordance with some embodiments. Accordingly, the system 400 may include a communication device 402, a processing device 404, and a storage device 406.

Further, the communication device 402 may be configured for receiving at least one request associated with at least one user from at least one device 502. Further, the communication device 402 may be configured for receiving at least one preference from at least one device 502. Further, the at least one preference may include at least one preferred characteristic associated with the at least one content and at least one device characteristic associated with the at least one device 502. Further, the communication device 402 may be configured for transmitting at least one personalized menu to the at least one device 502.

Further, the processing device 404 may be communicatively coupled with the communication device 402. Further, the processing device 404 may be configured for obtaining at least one menu associated with at least one restaurant based on the at least one request. Further, the at least one menu may include at least one content associated with at least one dish on the at least one menu. Further, the processing device 404 may be configured for translating the at least one content associated with the at least one dish based on the at least one preference by implementing at least one machine learning model. Further, the at least one machine learning model may include at least one convolutional neural network (CNN) model and at least one recurrent neural network (RNN) model. Further, the at least one RNN model may be trained for converting at least one original characteristic of at least one text of the at least one content to the at least one preferred characteristic based on the at least one preferred characteristic. Further, the at least one CNN model may be trained for generating at least one media content for the at least one dish renderable on the at least one device 502 based the at least one content, the at least one text with the at least one preferred characteristic, and the at least one device characteristic. Further, the translating of the at least one content may include the converting of the at least one original characteristic of the at least one text of the at least one content and the generating of the at least one media content. Further, the processing device 404 may be configured for generating the at least one personalized menu of the at least one restaurant for the at least one user based on the translating. Further, the at least one personalized menu may include the at least one media content for the at least one dish.

Further, the storage device 406 may be communicatively coupled with the processing device 404. Further, the storage device 406 may be configured for storing the at least one machine learning model.

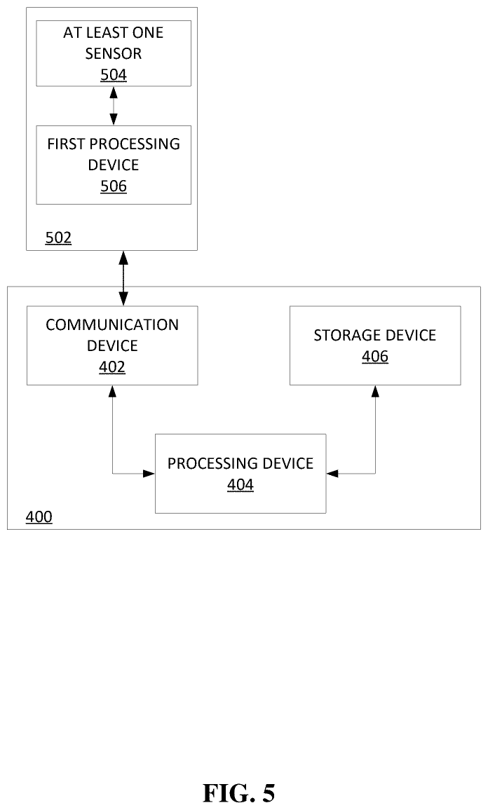

Further, in some embodiments, the at least one device 502 may include at least one sensor 504 and a first processing device 506, as shown in FIG. 5. Further, the at least one sensor 504 may be configured for generating at least one sensor data based on detecting at least one visual characteristic of the at least one user. Further, the first processing device 506 may be communicatively coupled with the at least one sensor 504. Further, the first processing device 506 may be configured for analyzing the at least one sensor data. Further, the first processing device 506 may be configured for determining a race and a physical trait of the at least one user based on the analyzing of the at least one sensor data. Further, the first processing device 506 may be configured for determining a geographical region for the at least one user based on the race and the physical trait of the at least one user by implementing at least one first machine learning model. Further, the at least one first machine learning model may be trained on a dataset comprising at least one classification of the geographical region based on a combination of the race and the physical trait in at least one proportion. Further, the first processing device 506 may be configured for generating at least one of a preferred language and a preferred currency based on the geographical region. Further, the at least one preferred characteristic may include at least one of the preferred language and the preferred currency. Further, the receiving of the at least one preference may be further based on the generating of at least one of the preferred language and the preferred currency.

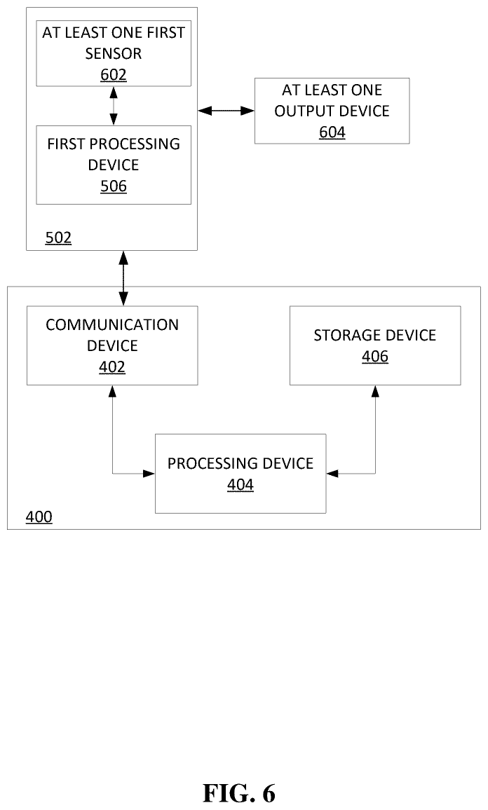

Further, in some embodiments, the at least one device 502 may be communicatively couplable to at least one output device 604 (as shown in FIG. 6). Further, the at least one device 502 may include at least one first sensor 602 (as shown in FIG. 6) and the first processing device 506. Further, the the at least one first sensor 602 may be configured for generating at least one indication based on detecting a communicative coupling of the at least one output device 604 with the at least one device 502. Further, the first processing device 506 may be communicatively coupled with the at least one first sensor 602. Further, the first processing device 506 may be configured for obtaining at least one output device data associated with the at least one output device 604 based on the at least one indication. Further, the first processing device 506 may be configured for analyzing the at least one output device data. Further, the first processing device 506 may be configured for generating at least one output device characteristic of the at least one output device 604 based on the analyzing of the at least one output device data. Further, the at least one device characteristic may include the at least one output device characteristic. Further, the receiving of the at least one preference may be further based on the generating of the at least one output device characteristic.

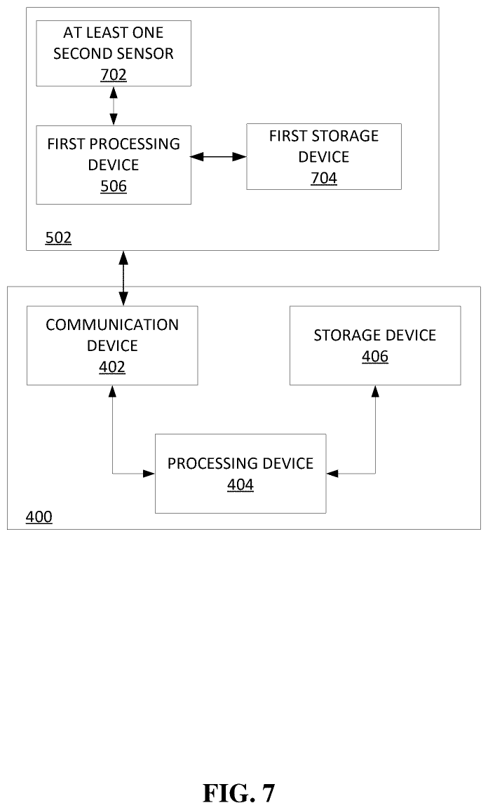

Further, in some embodiments, the at least one device 502 may include at least one second sensor 702 (as shown in FIG. 7), a first storage device 704 (as shown in FIG. 7), and the first processing device 506. Further, the at least one second sensor 702 may be configured for generating at least one location data based on detecting a current location of the at least one user. Further, the first storage device 704 may be configured for storing at least one payment information associated with the at least one user. Further, the at least one payment information may include at least one account comprising at least one amount in at least one currency. Further, the first processing device 506 may be communicatively coupled with the at least one second sensor 702 and the first storage device 704. Further, the first processing device 506 may be configured for determining a local currency used for payment in the current location based on the at least one location data. Further, the first processing device 506 may be configured for analyzing the local currency and the at least one payment data. Further, the first processing device 506 may be configured for determining a preferred currency from the at least one currency associated with the at least one account of the at least one user. Further, the at least one preferred characteristic may include the preferred currency. Further, the receiving of the at least one preference may be further based on the determining of the preferred currency.

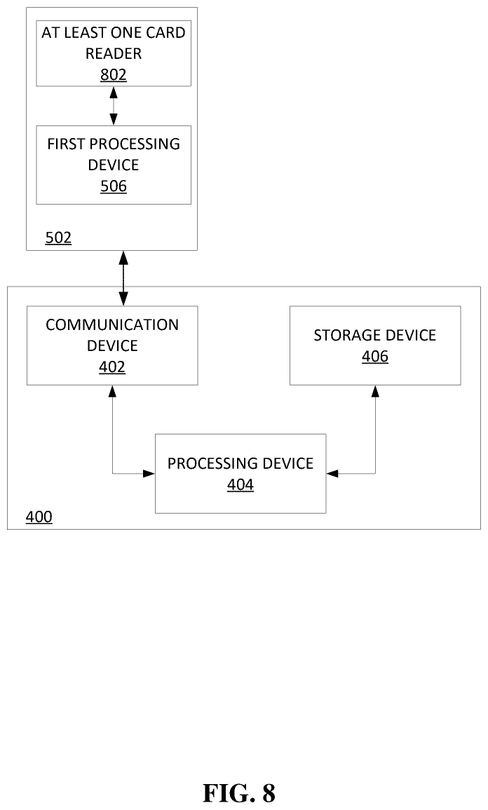

Further, in some embodiments, the at least one device 502 may include at least one card reader 802 (as shown in FIG. 8) and the first processing device 506. Further, the at least one card reader 802 may be configured for reading at least one payment information comprised in at least one card by detecting the at least one card. Further, the first processing device 506 may be communicatively coupled with the at least one card reader 802. Further, the first processing device 506 may be configured for analyzing the at least one payment information. Further, the first processing device 506 may be configured for determining a geographical region associated with the at least one user based on the analyzing of the at least one payment information. Further, the first processing device 506 may be configured for generating at least one of a preferred language and a preferred currency based on the geographical region. Further, the at least one preferred characteristic may include at least one of the preferred language and the preferred currency. Further, the receiving of the at least one preference may be further based on the generating of at least one of the preferred language and the preferred currency.

Further, in some embodiments, the at least one content may include at least one textual content. Further, the translating of the at least one content may include translating the at least one textual content into at least one graphical content. Further, the generating of the at least one media content for the at least one dish renderable on the at least one device 502 may include generating the at least one graphical content for the at least one dish renderable on the at least one device 502 based the at least one textual content. Further, the at least one media content may include the at least one graphical content.

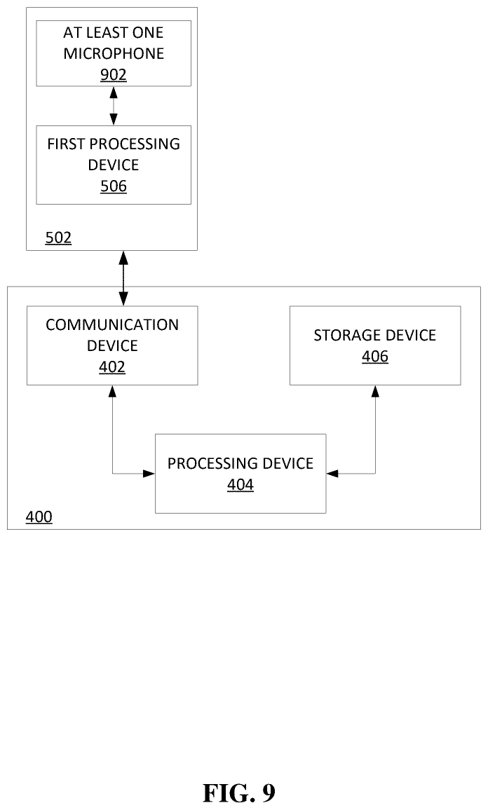

Further, in some embodiments, the at least one device 502 may include at least one microphone 902, (as shown in FIG. 9) and the first processing device 506. Further, the at least one microphone 902 may be configured for generating at least one utterance data by detecting an utterance from the at least one user. Further, the first processing device 506 may be communicatively coupled with the at least one microphone 902. Further, the first processing device 506 may be configured for analyzing the at least one utterance data. Further, the first processing device 506 may be configured for determining a dialect associated with the at least one user based on the analyzing of the at least one utterance data.

Further, the first processing device 506 may be configured for determining a geographical region for the at least one user based on the dialect of the at least one user by implementing at least one third machine learning model. Further, the at least one third machine learning model may be trained on a dataset comprising at least one classification of the geographical region based on the dialect. Further, the first processing device 506 may be configured for generating at least one of a preferred language and a preferred currency based on the geographical region. Further, the at least one preferred characteristic may include at least one of the preferred language and the preferred currency. Further, the receiving of the at least one preference may be further based on the generating of at least one of the preferred language and the preferred currency.

Further, in some embodiments, the at least one content may include at least one textual content comprising a list of ingredients for the at least one dish and at least one identifier of the at least one dish. Further, the processing device 404 may be configured for analyzing the at least one textual content by implementing at least one second machine learning model. Further, the at least one second machine learning model may be trained on a dataset comprising at least one classification of the at least one dish by the at least one identifier and an exhaustive list of ingredients for each of the at least one classification of the at least one dish. Further, the processing device 404 may be configured for identifying at least one missing ingredient absent from the list of ingredients based on the analyzing of the at least one textual content. Further, the processing device 404 may be configured for generating at least one modified textual content for the at least one dish based on the identifying of the at least one missing ingredient. Further, the translating of the at least one content may include translating the at least one modified textual content by the implementing of the at least one machine learning model. Further, the generating of the at least one personalized menu may be further based on the translating of the at least one modified textual content.

Further, in an embodiment, the converting of the at least one original characteristic of the at least one text of the at least one content may include converting the at least one original characteristic of at least one modified text of the at least one modified textual content to the at least one preferred characteristic based on the at least one preferred characteristic. Further, the translating of the at least one modified textual content may include the converting of the at least one original characteristic of the at least one modified text of the at least one modified textual content.

Further, in an embodiment, the generating of the at least one media content for the at least one dish renderable on the at least one device 502 may include generating the at least one media content for the at least one dish renderable on the at least one device 502 based on the at least one modified textual content, the at least one modified text with the at least one preferred characteristic, and the at least one device characteristic. Further, the translating of the at least one modified textual content further may include the generating of the at least one media content for the at least one dish renderable on the at least one device 502 based on the at least one modified textual content, the at least one modified text with the at least one preferred characteristic.

FIG. 5 is a block diagram of the system 400, in accordance with some embodiments.

FIG. 6 is a block diagram of the system 400, in accordance with some embodiments.

FIG. 7 is a block diagram of the system 400, in accordance with some embodiments.

FIG. 8 is a block diagram of the system 400, in accordance with some embodiments.

FIG. 9 is a block diagram of the system 400, in accordance with some embodiments.

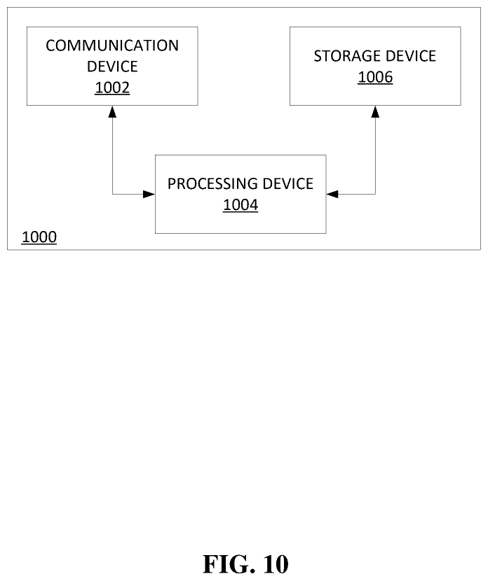

FIG. 10 is a block diagram of a system 1000 for facilitating converting a food menu based on user preferences, in accordance with some embodiments. Accordingly, the system 1000 may include a communication device 1002 configured for receiving user data associated with at least one user from at least one user device. Further, the user data may include name, address, email address, etc. Further, the communication device 1002 may be configured for transmitting a restaurant portfolio to the at least one user device. Further, the restaurant portfolio may include restaurant details of a plurality of restaurants. Further, the restaurant details may include a photo, a name, an address, a contact number, etc. Further, the communication device 1002 may be configured for receiving a selection corresponding to at least one restaurant from the at least one user device. Further, the communication device 1002 may be configured for receiving at least one user preference associated with a menu corresponding to at least one restaurant from the at least one user device. Further, the at least one user preference may include a language preference and a currency preference. Further, the at least one user preference may represent a language and a currency in which the at least one user may want to view the menu. Further, the communication device 1002 may be configured for transmitting a personalized menu to the at least one user device.

Further, the system 1000 may include a processing device 1004 communicatively coupled with the communication device 1002. Further, the processing device 1004 may be configured for generating a user profile associated with the at least one user based on the user data. Further, the processing device 1004 may be configured for updating the menu based on the at least one user preference using at least one machine learning algorithm. Further, the processing device 1004 may be configured for generating the personalized menu based on the updating. Further, the personalized menu may include details of the at least one dish served in the at least one restaurant in a language and a currency preferred by the at least one user.

Further, the system 1000 may include a storage device 1006 communicatively coupled with the communication device 1002. Further, the storage device 1006 may be configured for retrieving the menu associated with the at least one restaurant based on the selection. Further, the menu may include details of at least one dish served in the at least one restaurant. Further, the menu may be available in a default language with a price in a default currency.

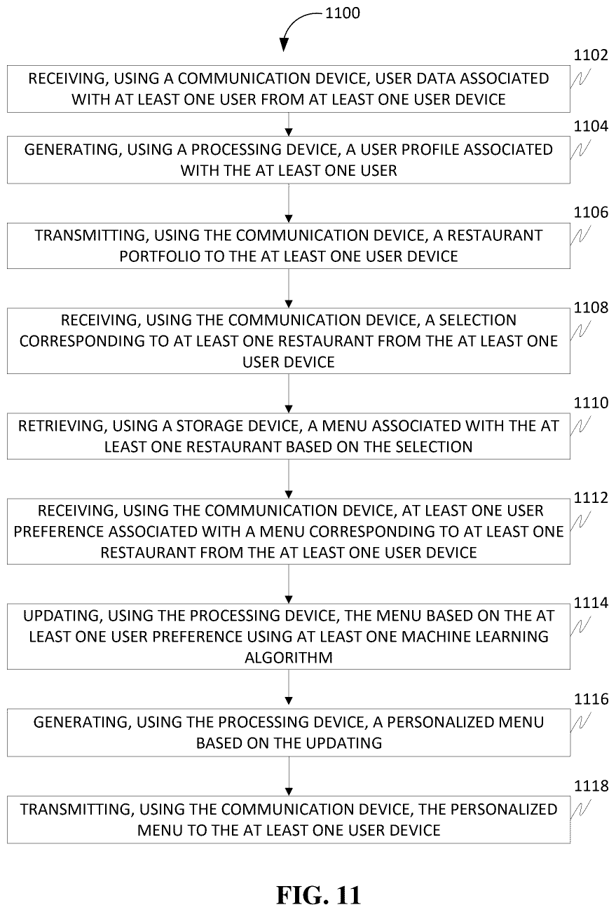

FIG. 11 is a flow chart of a method 1100 for facilitating converting a food menu based on user preferences, in accordance with some embodiments. Accordingly, at 1102, the method 1100 may include receiving, using a communication device, user data associated with at least one user from at least one user device. Further, the user data may include name, address, email address, etc. Further, the at least one user device may include a smartphone, a tablet, a mobile, a laptop, etc.

Further, at 1104, the method 1100 may include generating, using a processing device, a user profile associated with the at least one user based on the user data.

Further, at 1106, the method 1100 may include transmitting, using the communication device, a restaurant portfolio to the at least one user device. Further, the restaurant portfolio may include restaurant details of a plurality of restaurants. Further, the restaurant details may include a photo, a name, an address, a contact number, etc.

Further, at 1108, the method 1100 may include receiving, using the communication device, a selection corresponding to at least one restaurant from the at least one user device. Further, the plurality of restaurants may include the at least one restaurant.

Further, at 1110, the method 1100 may include retrieving, using a storage device, a menu associated with the at least one restaurant based on the selection. Further, the menu may include details of at least one dish served in the at least one restaurant. Further, the menu may be available in a default language with a price in a default currency. Further, the at least one user may include an individual that may want to perform text conversion and currency conversion of the menu (or food menu) of the at least one restaurant.

Further, at 1112, the method 1100 may include receiving, using the communication device, at least one user preference associated with a menu corresponding to at least one restaurant from the at least one user device. Further, the at least one user preference may include a language preference and a currency preference. Further, the at least one user preference may represent a preferred language in which the at least one user may want to view the menu and a preferred currency in which the at least one user may want to pay for the at least one dish (or food). Further, the default currency may be translated to the preferred currency preferred by the at least one user based on an exchange rate.

Further, at 1114, the method 1100 may include updating, using the processing device, the menu based on the at least one user preference using at least one machine learning algorithm. Further, the at least one machine learning algorithm may include a natural language processing algorithm for translating a textual content, comprised in the menu, from the default language to the preferred language. Further, the at least one machine learning algorithm may include a second machine learning algorithm configured to convert an amount in the default currency to the preferred currency based on analyzing the real-time change in the exchange rate (or currency conversion rates) associated with the default currency and the preferred currency.

Further, at 1116, the method 1100 may include generating, using the processing device, a personalized menu based on the updating. Further, the personalized menu may include details of the at least one dish served in the at least one restaurant in the preferred language and the preferred currency.

Further, at 1118, the method 1100 may include transmitting, using the communication device, the personalized menu to the at least one user device.

Further, in some embodiments, the method 1100 may include receiving, using the communication device, at least one sensor data from the at least one sensor. Further, the at least one sensor may include a QR code sensor, an image sensor, etc. Further, the at least one sensor may be configured for generating the at least one sensor data based on scanning a QR code. Further, the at least one sensor may be comprised in the at least one user device. Further, the QR code may be present on at least one physical menu associated with the at least one restaurant. Further, the at least one physical menu may be present at a point of sale in the at least one restaurant. Further, the retrieving of the menu may be based on the at least one sensor data.

Further, in some embodiments, the method 1100 may include generating, using the processing device, artificial reality (AR) data based on the personalized menu using a machine learning algorithm. Further, the artificial reality data may include the personalized menu in an artificial reality environment. Further, the method 1100 may include transmitting, using the communication device, the personalized menu to at least one output device. Further, the at least one output device may include a virtual reality headset, an artificial reality (AR) headset (or goggles), etc. Further, the at least one user may view the AR data in a metaverse using the at least one output device.

Further, in some embodiments, the method 1100 may include retrieving, using the storage device, at least one dish data associated with the at least one dish being served in the at least one restaurant. Further, the at least one dish data may include a graphical content. Further, the graphical content may include an image, a video of preparing the dish, an ingredient list, an allergens warning, etc. Further, the method 1100 may include transmitting, using the communication device, the at least one dish data to at least one of the at least one output device and the at least one user device.

Further, in some embodiments, the at least one user preference may include a dish preference. Further, the dish preference may include a vegetarian food preference and a non-vegetarian food preference. Further, in some embodiments, the non-vegetarian food preference may include at least one sub preference such as meat preference (such as mutton, beef, chicken, seafood, etc.). Further, in an instance, if the at least one user wants to eat mutton, then the at least one user may provide a non-vegetarian food preference with the sub preference comprising mutton. Further, the method 1100 may include modifying, using the processing device, the menu based on the at least one user preference. Further, the generating of the personalized menu may be based on the modifying. Further, in another instance, if the at least one user has provided a vegetarian food preference, the personalized menu may only show at least one vegetarian dish of the at least one dish.

Further, in some embodiments, the at least one user preference may include allergen information associated with the at least one user. Further, the allergen information may include details of food or ingredient in the at least one dish to which the at least one user is allergic. Further, the method 1100 may include analyzing, using the processing device, the at least one dish data and the at least one user preference. Further, the method 1100 may include generating, using the processing device, a notification based on the analyzing of the at least one dish data and the at least one user preference.

Further, in some embodiments, the at least one sensor data may include a location data generated by a location sensor. Further, the at least one user device may include the location sensor that automatically detects a location of the at least one user and generates the location data. Further, the generating of the personalized menu may be based on the location data.

Further, in some embodiments, the method 1100 may include receiving, using the communication device, a food request from the at least one user device. Further, the food request may include the at least one dish that the at least one user may want to have (or eat). Further, the method 1100 may include generating, using the processing device, an order associated with the food request based on the food request. Further, the order invoice comprises a bill amount for the at least one dish. Further, the bill amount (or order amount) may include a price of the at least one dish had by the at least one user. Further, the method 1100 may include transmitting, using the communication device, the order invoice to the at least one user device. Further, the method 1100 may include receiving, using the communication device, a payment information corresponding to the order invoice from the at least one user device. Further, the method 1100 may include processing, using the processing device, a transaction based on the payment information.

Further, in some embodiments, the payment information may include a payment mode information associated with at least one payment mode. Further, the at least one payment mode may include a credit card, a debit card, a prepaid card, a travel card, etc. Further, the at least one user may use the at least one payment mode to make payment for the order amount. Further, the method 1100 may include determining, using the processing device, a transaction cost associated with the at least one payment mode. Further, a transaction cost for a first payment mode of the at least one payment mode may be different from a second transaction cost for a second payment mode of the at least one payment mode. Further, the method 1100 may include transmitting, using the communication device, the transaction cost to the at least one user device. Further, in an instance, the transaction cost varies for credit cards, debit cards, prepaid cards, travel cards, etc.

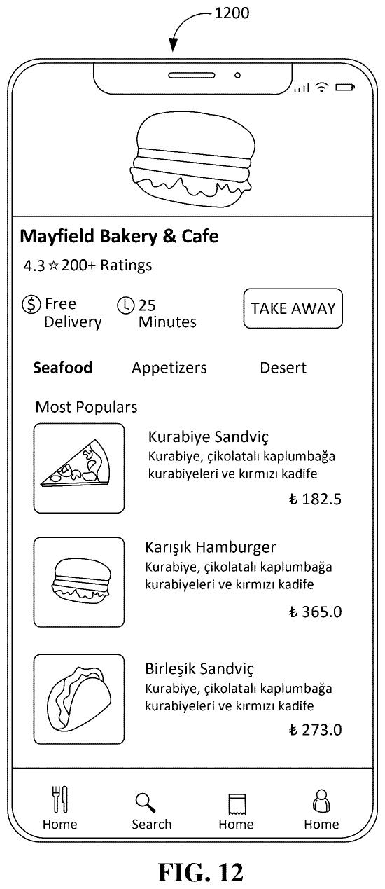

FIG. 12 is a screenshot of a user interface 1200 of a software application displaying a food menu in an original (or default) language and an original (or default) currency, in accordance with some embodiments.

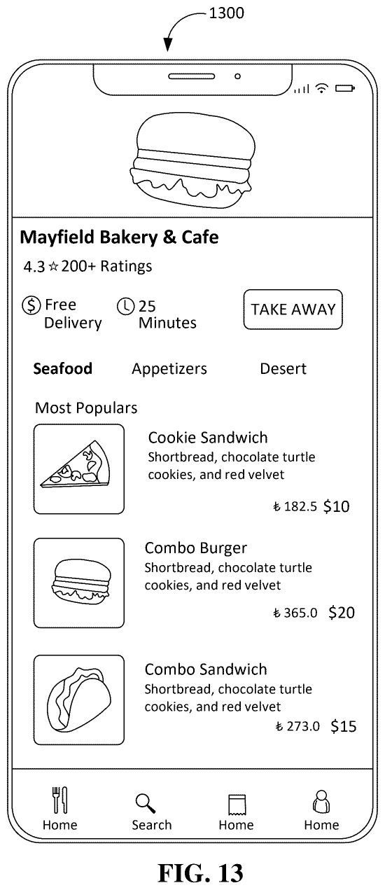

FIG. 13 is a screenshot of a user interface 1300 of the software application displaying the food menu in a preferred language and a preferred currency, in accordance with some embodiments.

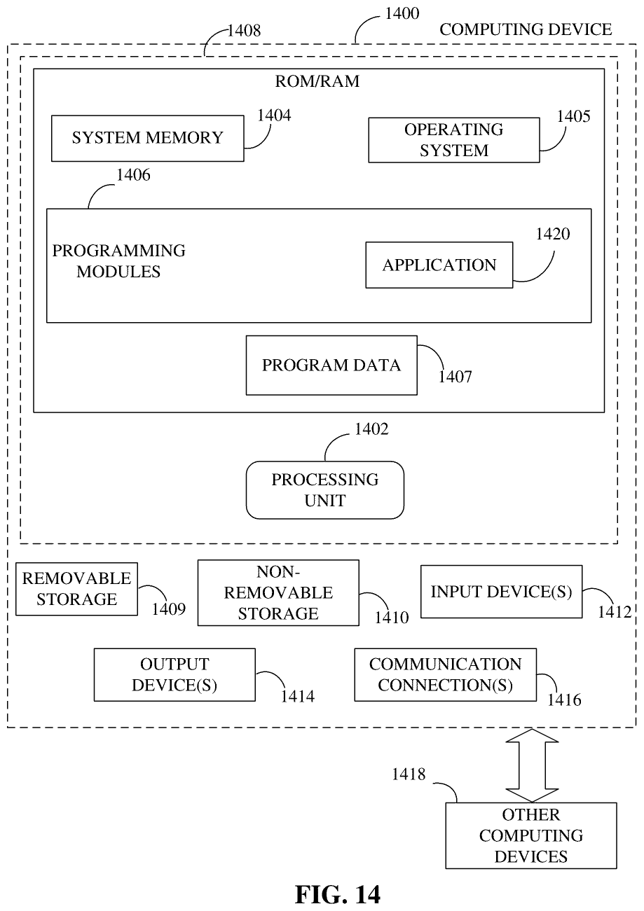

With reference to FIG. 14, a system consistent with an embodiment of the disclosure may include a computing device or cloud service, such as computing device 1400. In a basic configuration, computing device 1400 may include at least one processing unit 1402 and a system memory 1404. Depending on the configuration and type of computing device, system memory 1404 may comprise, but is not limited to, volatile (e.g. random-access memory (RAM)), non-volatile (e.g. read-only memory (ROM)), flash memory, or any combination. System memory 1404 may include operating system 1405, one or more programming modules 1406, and may include a program data 1407. Operating system 1405, for example, may be suitable for controlling computing device 1400's operation. In one embodiment, programming modules 1406 may include image-processing module, machine learning module. Furthermore, embodiments of the disclosure may be practiced in conjunction with a graphics library, other operating systems, or any other application program and is not limited to any particular application or system. This basic configuration is illustrated in FIG. 14 by those components within a dashed line 1408.

Computing device 1400 may have additional features or functionality. For example, computing device 1400 may also include additional data storage devices (removable and/or non-removable) such as, for example, magnetic disks, optical disks, or tape. Such additional storage is illustrated in FIG. 14 by a removable storage 1409 and a non-removable storage 1410. Computer storage media may include volatile and non-volatile, removable and non-removable media implemented in any method or technology for storage of information, such as computer-readable instructions, data structures, program modules, or other data. System memory 1404, removable storage 1409, and non-removable storage 1410 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 1400. Any such computer storage media may be part of device 1400. Computing device 1400 may also have input device(s) 1412 such as a keyboard, a mouse, a pen, a sound input device, a touch input device, a location sensor, a camera, a biometric sensor, etc. Output device(s) 1414 such as a display, speakers, a printer, etc. may also be included. The aforementioned devices are examples and others may be used.

Computing device 1400 may also contain a communication connection 1416 that may allow device 1400 to communicate with other computing devices 1418, such as over a network in a distributed computing environment, for example, an intranet or the Internet. Communication connection 1416 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 1404, including operating system 1405. While executing on processing unit 1402, programming modules 1406 (e.g., application 1420 such as a media player) may perform processes including, for example, one or more stages of methods, algorithms, systems, applications, servers, databases as described above. The aforementioned process is an example, and processing unit 1402 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment, it is to be understood that many other possible modifications and variations can be made without departing from the spirit and scope of the disclosure.

What is claimed is:

1. A method for personalizing menus of restaurants based on preferences, the method comprising:
receiving, using a communication device, at least one request associated with at least one user from at least one device;
obtaining, using a processing device, at least one menu associated with at least one restaurant based on the at least one request, wherein the at least one menu comprises at least one content associated with at least one dish on the at least one menu;
receiving, using the communication device, at least one preference from at least one device, wherein the at least one preference comprises at least one preferred characteristic associated with the at least one content and at least one device characteristic associated with the at least one device;
translating, using the processing device, the at least one content associated with the at least one dish based on the at least one preference by implementing at least one machine learning model, wherein the at least one machine learning model comprises at least one convolutional neural network (CNN) model and at least one recurrent neural network (RNN) model, wherein the at least one RNN model is trained for converting at least one original characteristic of at least one text of the at least one content to the at least one preferred characteristic based on the at least one preferred characteristic, wherein the at least one CNN model is trained for generating at least one media content for the at least one dish renderable on the at least one device based the at least one content, the at least one text with the at least one preferred characteristic, and the at least one device characteristic, wherein the translating of the at least one content comprises the converting of the at least one original characteristic of the at least one text of the at least one content and the generating of the at least one media content;
generating, using the processing device, at least one personalized menu of the at least one restaurant for the at least one user based on the translating, wherein the at least one personalized menu comprises the at least one media content for the at least one dish;
transmitting, using the communication device, the at least one personalized menu to the at least one device; and
storing, using a storage device, the at least one machine learning model.

2. The method of claim 1, wherein the at least one device comprises:
at least one sensor configured for generating at least one sensor data based on detecting at least one visual characteristic of the at least one user; and
a first processing device communicatively coupled with the at least one sensor, wherein the first processing device is configured for:
analyzing the at least one sensor data;
determining a race and a physical trait of the at least one user based on the analyzing of the at least one sensor data;
determining a geographical region for the at least one user based on the race and the physical trait of the at least one user by implementing at least one first machine learning model, wherein the at least one first machine learning model is trained on a dataset comprising at least one classification of the geographical region based on a combination of the race and the physical trait in at least one proportion; and
generating at least one of a preferred language and a preferred currency based on the geographical region, wherein the at least one preferred characteristic comprises at least one of the preferred language and the preferred currency, wherein the receiving of the at least one preference is further based on the generating of at least one of the preferred language and the preferred currency.

3. The method of claim 1, wherein the at least one device is communicatively couplable to at least one output device, wherein the at least one device comprises:
at least one first sensor configured for generating at least one indication based on detecting a communicative coupling of the at least one output device with the at least one device; and
a first processing device communicatively coupled with the at least one first sensor, wherein the first processing device is configured for:
obtaining at least one output device data associated with the at least one output device based on the at least one indication;
analyzing the at least one output device data; and
generating at least one output device characteristic of the at least one output device based on the analyzing of the at least one output device data, wherein the at least one device characteristic comprises the at least one output device characteristic, wherein the receiving of the at least one preference is further based on the generating of the at least one output device characteristic.

4. The method of claim 1, wherein the at least one device comprises:
at least one second sensor configured for generating at least one location data based on detecting a current location of the at least one user;
a storage device configured for storing at least one payment information associated with the at least one user, wherein the at least one payment information comprises at least one account comprising at least one amount in at least one currency; and
a first processing device communicatively coupled with the at least one second sensor and the storage device, wherein the first processing device is configured for:
determining a local currency used for payment in the current location based on the at least one location data;
analyzing the local currency and the at least one payment data; and
determining a preferred currency from the at least one currency associated with the at least one account of the at least one user, wherein the at least one preferred characteristic comprises the preferred currency, wherein the receiving of the at least one preference is further based on the determining of the preferred currency.

5. The method of claim 1, wherein the at least one device comprises:
at least one card reader configured for reading at least one payment information comprised in at least one card by detecting the at least one card; and
a first processing device communicatively coupled with the at least one card reader, wherein the first processing device is configured for:
analyzing the at least one payment information;
determining a geographical region associated with the at least one user based on the analyzing of the at least one payment information; and
generating at least one of a preferred language and a preferred currency based on the geographical region, wherein the at least one preferred characteristic comprises at least one of the preferred language and the preferred currency, wherein the receiving of the at least one preference is further based on the generating of at least one of the preferred language and the preferred currency.

6. The method of claim 1, wherein the at least one content comprises at least one textual content, wherein the translating of the at least one content comprises translating the at least one textual content into at least one graphical content, wherein the generating of the at least one media content for the at least one dish renderable on the at least one device comprises generating the at least one graphical content for the at least one dish renderable on the at least one device based the at least one textual content, wherein the at least one media content comprises the at least one graphical content.

7. The method of claim 1, wherein the at least one content comprises at least one textual content comprising a list of ingredients for the at least one dish and at least one identifier of the at least one dish, wherein the method further comprises:
analyzing, using the processing device, the at least one textual content by implementing at least one second machine learning model, wherein the at least one second machine learning model is trained on a dataset comprising at least one classification of the at least one dish by the at least one identifier and an exhaustive list of ingredients for each of the at least one classification of the at least one dish;
identifying, using the processing device, at least one missing ingredient absent from the list of ingredients based on the analyzing of the at least one textual content; and
generating, using the processing device, at least one modified textual content for the at least one dish based on the identifying of the at least one missing ingredient, wherein the translating of the at least one content comprises translating the at least one modified textual content by the implementing of the at least one machine learning model, wherein the generating of the at least one personalized menu is further based on the translating of the at least one modified textual content.

8. The method of claim 7, wherein the converting of the at least one original characteristic of the at least one text of the at least one content comprises converting the at least one original characteristic of at least one modified text of the at least one modified textual content to the at least one preferred characteristic based on the at least one preferred characteristic, wherein the translating of the at least one modified textual content comprises the converting of the at least one original characteristic of the at least one modified text of the at least one modified textual content.

9. The method of claim 8, wherein the generating of the at least one media content for the at least one dish renderable on the at least one device comprises generating the at least one media content for the at least one dish renderable on the at least one device based on the at least one modified textual content, the at least one modified text with the at least one preferred characteristic, and the at least one device characteristic, wherein the translating of the at least one modified textual content further comprises the generating of the at least one media content for the at least one dish renderable on the at least one device based on the at least one modified textual content, the at least one modified text with the at least one preferred characteristic.

10. The method of claim 1, wherein the at least one device comprises:
at least one microphone configured for generating at least one utterance data by detecting an utterance from the at least one user; and
a first processing device communicatively coupled with the at least one microphone, wherein the first processing device is configured for:
analyzing the at least one utterance data;
determining a dialect associated with the at least one user based on the analyzing of the at least one utterance data;
determining a geographical region for the at least one user based on the dialect of the at least one user by implementing at least one third machine learning model, wherein the at least one third machine learning model is trained on a dataset comprising at least one classification of the geographical region based on the dialect; and
generating at least one of a preferred language and a preferred currency based on the geographical region, wherein the at least one preferred characteristic comprises at least one of the preferred language and the preferred currency, wherein the receiving of the at least one preference is further based on the generating of at least one of the preferred language and the preferred currency.

11. A system for personalizing menus of restaurants based on preferences, the system comprising:
a communication device configured for:
receiving at least one request associated with at least one user from at least one device;
receiving at least one preference from at least one device, wherein the at least one preference comprises at least one preferred characteristic associated with the at least one content and at least one device characteristic associated with the at least one device; and
transmitting at least one personalized menu to the at least one device;
a processing device communicatively coupled with the communication device, wherein the processing device is configured for:
obtaining at least one menu associated with at least one restaurant based on the at least one request, wherein the at least one menu comprises at least one content associated with at least one dish on the at least one menu;
translating the at least one content associated with the at least one dish based on the at least one preference by implementing at least one machine learning model, wherein the at least one machine learning model comprises at least one convolutional neural network (CNN) model and at least one recurrent neural network (RNN) model, wherein the at least one RNN model is trained for converting at least one original characteristic of at least one text of the at least one content to the at least one preferred characteristic based on the at least one preferred characteristic, wherein the at least one CNN model is trained for generating at least one media content for the at least one dish renderable on the at least one device based the at least one content, the at least one text with the at least one preferred characteristic, and the at least one device characteristic, wherein the translating of the at least one content comprises the converting of the at least one original characteristic of the at least one text of the at least one content and the generating of the at least one media content; and
generating the at least one personalized menu of the at least one restaurant for the at least one user based on the translating, wherein the at least one personalized menu comprises the at least one media content for the at least one dish; and
a storage device communicatively coupled with the processing device, wherein the storage device is configured for storing the at least one machine learning model.

12. The system of claim 11, wherein the at least one device comprises:
at least one sensor configured for generating at least one sensor data based on detecting at least one visual characteristic of the at least one user; and
a first processing device communicatively coupled with the at least one sensor, wherein the first processing device is configured for:
analyzing the at least one sensor data;
determining a race and a physical trait of the at least one user based on the analyzing of the at least one sensor data;
determining a geographical region for the at least one user based on the race and the physical trait of the at least one user by implementing at least one first machine learning model, wherein the at least one first machine learning model is trained on a dataset comprising at least one classification of the geographical region based on a combination of the race and the physical trait in at least one proportion; and
generating at least one of a preferred language and a preferred currency based on the geographical region, wherein the at least one preferred characteristic comprises at least one of the preferred language and the preferred currency, wherein the receiving of the at least one preference is further based on the generating of at least one of the preferred language and the preferred currency.

13. The system of claim 11, wherein the at least one device is communicatively couplable to at least one output device, wherein the at least one device comprises:
at least one first sensor configured for generating at least one indication based on detecting a communicative coupling of the at least one output device with the at least one device; and
a first processing device communicatively coupled with the at least one first sensor, wherein the first processing device is configured for:
obtaining at least one output device data associated with the at least one output device based on the at least one indication;
analyzing the at least one output device data; and
generating at least one output device characteristic of the at least one output device based on the analyzing of the at least one output device data, wherein the at least one device characteristic comprises the at least one output device characteristic, wherein the receiving of the at least one preference is further based on the generating of the at least one output device characteristic.

14. The system of claim 11, wherein the at least one device comprises:
at least one second sensor configured for generating at least one location data based on detecting a current location of the at least one user;
a storage device configured for storing at least one payment information associated with the at least one user, wherein the at least one payment information comprises at least one account comprising at least one amount in at least one currency; and
a first processing device communicatively coupled with the at least one second sensor and the storage device, wherein the first processing device is configured for:
determining a local currency used for payment in the current location based on the at least one location data;
analyzing the local currency and the at least one payment data; and
determining a preferred currency from the at least one currency associated with the at least one account of the at least one user, wherein the at least one preferred characteristic comprises the preferred currency, wherein the receiving of the at least one preference is further based on the determining of the preferred currency.

15. The system of claim 11, wherein the at least one device comprises:
at least one card reader configured for reading at least one payment information comprised in at least one card by detecting the at least one card; and
a first processing device communicatively coupled with the at least one card reader, wherein the first processing device is configured for:
analyzing the at least one payment information;
determining a geographical region associated with the at least one user based on the analyzing of the at least one payment information; and
generating at least one of a preferred language and a preferred currency based on the geographical region, wherein the at least one preferred characteristic comprises at least one of the preferred language and the preferred currency, wherein the receiving of the at least one preference is further based on the generating of at least one of the preferred language and the preferred currency.

16. The system of claim 11, wherein the at least one content comprises at least one textual content, wherein the translating of the at least one content comprises translating the at least one textual content into at least one graphical content, wherein the generating of the at least one media content for the at least one dish renderable on the at least one device comprises generating the at least one graphical content for the at least one dish renderable on the at least one device based the at least one textual content, wherein the at least one media content comprises the at least one graphical content.

17. The system of claim 11, wherein the at least one content comprises at least one textual content comprising a list of ingredients for the at least one dish and at least one identifier of the at least one dish, wherein the processing device is further configured for:
analyzing the at least one textual content by implementing at least one second machine learning model, wherein the at least one second machine learning model is trained on a dataset comprising at least one classification of the at least one dish by the at least one identifier and an exhaustive list of ingredients for each of the at least one classification of the at least one dish;
identifying at least one missing ingredient absent from the list of ingredients based on the analyzing of the at least one textual content; and
generating at least one modified textual content for the at least one dish based on the identifying of the at least one missing ingredient, wherein the translating of the at least one content comprises translating the at least one modified textual content by the implementing of the at least one machine learning model, wherein the generating of the at least one personalized menu is further based on the translating of the at least one modified textual content.

18. The system of claim 17, wherein the converting of the at least one original characteristic of the at least one text of the at least one content comprises converting the at least one original characteristic of at least one modified text of the at least one modified textual content to the at least one preferred characteristic based on the at least one preferred characteristic, wherein the translating of the at least one modified textual content comprises the converting of the at least one original characteristic of the at least one modified text of the at least one modified textual content.

19. The system of claim 18, wherein the generating of the at least one media content for the at least one dish renderable on the at least one device comprises generating the at least one media content for the at least one dish renderable on the at least one device based on the at least one modified textual content, the at least one modified text with the at least one preferred characteristic, and the at least one device characteristic, wherein the translating of the at least one modified textual content further comprises the generating of the at least one media content for the at least one dish renderable on the at least one device based on the at least one modified textual content, the at least one modified text with the at least one preferred characteristic.

20. The system of claim 11, wherein the at least one device comprises:
at least one microphone configured for generating at least one utterance data by detecting an utterance from the at least one user; and
a first processing device communicatively coupled with the at least one microphone, wherein the first processing device is configured for:
analyzing the at least one utterance data;
determining a dialect associated with the at least one user based on the analyzing of the at least one utterance data;
determining a geographical region for the at least one user based on the dialect of the at least one user by implementing at least one third machine learning model, wherein the at least one third machine learning model is trained on a dataset comprising at least one classification of the geographical region based on the dialect; and
generating at least one of a preferred language and a preferred currency based on the geographical region, wherein the at least one preferred characteristic comprises at least one of the preferred language and the preferred currency, wherein the receiving of the at least one preference is further based on the generating of at least one of the preferred language and the preferred currency.
